(19) United States
(12) Patent Application Publication
(10) Pub. No.: US 2019/0302855 A1
(43) Pub. Date: Oct. 3, 2019

(54) WIRELESS POWER RECEIVING DEVICE

(71) Applicant: LG INNOTEK CO., LTD., Seoul (KR)

(72) Inventor: Ki Min LEE, Seoul (KR)

(73) Assignee: LG INNOTEK CO., LTD., Seoul (KR)

(21) Appl. No.: 16/348,069

(22) PCT Filed: Nov. 24, 2017
(86) PCT No.: PCT/KR2017/013466

§ 371 Date: May 7, 2019

(30) Foreign Application Priority Data
Nov. 29, 2016 (KR) 10-2016-0160225

(51) Int. Cl. G06F 1/16; H02J 7/02; H02J 50/10

(52) U.S. Cl. CPC G06F 1/1683; H02J 50/10; H02J 7/025

(57) ABSTRACT

The present invention relates to a wireless power receiving device, and a wireless power receiving device having a metal body, according to one embodiment of the present invention, comprises: a hole formed on one side of the metal body; a first opening part respectively connected to the hole and a second opening part which divides an upper part or a lower part of the metal body; and a receiving coil which receives electromagnetic fields from a wireless power transmitting device for transmitting wireless power to the wireless power receiving device, wherein an outer diameter of the receiving coil can be larger than an outer diameter of the hole. Therefore, the present invention has an advantage of minimizing heat emission in the wireless power receiving device having a metal body and improving wireless power transmission efficiency.

### TECHNICAL FIELD

Embodiments relate to wireless power transmission technology, and more particularly, to a structure of a reception antenna and a wireless power reception device including the corresponding reception antenna installed therein, for maximizing wireless power reception efficiency of a wireless power reception device including a metal body and minimizing a heating phenomenon.

### BACKGROUND ART

Recently, with development of information and communication technology, a society based on ubiquitous information and communication technology has been formed.

In order to connect information and communication apparatuses anywhere and at anytime, sensors each having a computer chip having a communication function need to be installed in all social facilities. Accordingly, issues related to supply of power to such apparatuses or sensors have newly arisen. In addition, as portable apparatuses such as mobile phones, Bluetooth handsets and music players such as iPod have rapidly increased, it takes time and effort for a user to charge batteries. As a method for solving such an issue, recently, wireless power transmission technology is attracting considerable attention.

Wireless power transmission or wireless energy transfer technology refers to technology of wirelessly transmitting electric energy from a transmitter to a receiver using the principle of magnetic induction. Commonly used electric toothbrushes or electric razors are charged using the principle of electromagnetic induction.

Up to now, a wireless energy transfer method may be roughly divided into a magnetic induction method, a magnetic resonance method and a power transmission method using a short-wavelength radio frequency.

The magnetic induction method refers to technology of using a phenomenon that, when two coils are adjacently placed and current is supplied to one coil, a magnetic flux is generated to generate electromotive force in the other coil, and is commercially available in small apparatuses such as mobile phones. The magnetic induction method may transmit power of a maximum of several kilowatts (kW) and has high efficiency. However, since a maximum transmission distance is 1 cm or less, an apparatus needs to be generally located to be adjacent to a charger or the ground.

The magnetic resonance method uses magnetic induction of a non-radiative magnetic field and structured resonance or circuit resonance of an antenna. The magnetic resonance method is hardly influenced by an electromagnetic wave and thus is harmless to other electronic apparatuses and humans. In contrast, the magnetic resonance method may be used at a limited distance and in a limited space and energy transmission efficiency is slightly low in the case of transmission at a long distance.

The short-wavelength wireless power transmission method—briefly referred to as an RF method—uses a method of directly transmitting and receiving energy in the form of radio waves. This technology is an RF type wireless power transmission method using a rectenna. Rectenna is a compound word of “antenna” and “rectifier” and means an element for directly converting RF power into direct current (DC) power. That is, the RF method is technology of converting AC radio waves into DC radio waves and using DC radio waves and, recently, research into commercialization thereof has been actively conducted as efficiency is improved.

Wireless power transmission technology may be variously used in IT, railroad and consumer-electronics in addition to the mobile industry.

In accordance with recent trends, a body and frame of a smartphone has been changed to a metal-based material from a conventional plastic-based material in order to reduce the thickness of the smartphone and to enhance a heat dissipation structure.

However, a conventional wireless power reception device including a metal body has an issue in that wireless power transmission efficiency is degraded due to influence of a metal body based on a magnetic field transmitted from a wireless power transmission apparatus or a magnetic field transmitted from a near field communication (NFC) transmission apparatus and heat is also generated from the metal body.

### DISCLOSURE

### Technical Problem

Embodiments provide a wireless power reception device for maximizing wireless power transmission efficiency and minimizing heating.

Embodiments provide a wireless power reception device for preventing power transmission efficiency from being degraded due to influence of a metal body.

Objects of the embodiments are not limited to the above objects and features of the embodiments will be set forth in part in the description which follows and in part will become apparent to those having ordinary skill in the art upon examination of the following or may be learned from practice of the embodiments.

### Technical Solution

Embodiments provide a wireless power reception apparatus.

In one embodiment, a wireless power reception apparatus including a metal body includes a hole formed in one side of the metal body, a second opening configured to separate an upper or lower portion of the metal body, a first opening configured to be continuously connected to each of the second opening and the hole, and a reception coil configured to receive a magnetic field from a wireless power transmission apparatus for wirelessly transmitting power to the wireless power reception apparatus, wherein an outer diameter of the reception coil is larger than an outer diameter of the hole.

In some embodiments, the reception coil may be wound in a circular form along the outer diameter of the hole.

In some embodiments, an inner diameter of the reception coil may be smaller than the outer diameter of the hole.

In some embodiments, an inner diameter of the reception coil may be larger than the outer diameter of the hole.

In some embodiments, the reception coil may be disposed inside a first region, and the first region may be defined by a first line and a second line that are spaced apart from an upper second opening and a lower second opening by a predetermined height, respectively, and a third line and a fourth line that are spaced apart from a left edge of the metal body and a right edge of the metal body by a predetermined width, respectively

In some embodiments, the predetermined height may be a height obtained by reducing a distance between the upper second opening and an upper outer diameter of the hole or a distance between the lower second opening and a lower outer diameter of the hole by a first ratio, and the predetermined width may be a width obtained by reducing a distance between a left edge of the metal body and a left outer diameter of the hole or a distance between a right edge of the metal body and a right outer diameter of the hole by a second ratio.

In some embodiments, the first ratio and the second ratio may each be 50%

In some embodiments, the first opening and the second opening may be formed of a non-conductive material.

In some embodiments, the wireless power reception apparatus may further include plastic film attached to one surface of the reception coil through an adhesive sheet and having one surface that is externally exposed through the hole.

In some embodiments, a diameter and a coil thickness of the reception coil are determined depending on a diameter of the hole formed in the metal body.

In some embodiments, a diameter of the hole formed in the metal body may be determined depending on a diameter of a transmission coil installed in the wireless power transmission apparatus.

It is to be understood that both the foregoing general description and the following detailed description of the embodiments are exemplary and explanatory and are intended to provide further explanation of the embodiments as claimed

### Advantageous Effects

The method and apparatus according to embodiments may have the following advantageous effects.

Embodiments provide a wireless power transmission and reception device for maximizing wireless power transmission efficiency and minimizing heating.

Embodiments provide a wireless power reception device for preventing power transmission efficiency from being degraded due to influence of a metal body.

Embodiments provides a wireless power reception device from preventing heat from being generated from a metal body due to a magnetic field transmitted through a transmission coil or near field communication (NFC) antenna of a wireless power transmission apparatus.

It will be appreciated by persons skilled in the art that that the effects that could be achieved with the embodiments are not limited to what has been particularly described hereinabove and other advantages of the embodiments will be more clearly understood from the following detailed description taken in conjunction with the accompanying drawings.

### DESCRIPTION OF DRAWINGS

The accompanying drawings, which are included to provide a further understanding of the present disclosure, illustrate embodiments of the present disclosure and together with the description serve to explain the principle of the present disclosure.

In the drawings:

FIG. 1 is a diagram for explanation of a structure of a conventional wireless power reception apparatus;

FIG. 2 is a cross-sectional view for explanation of a structure in which a wireless power reception antenna is installed in a wireless power reception device according to an embodiment;

FIG. 3 is a diagram showing a structure of a system for explanation of a wireless power transmission method in a magnetic resonance method according to an embodiment;

FIG. 4 is a diagram for explanation of operations of a wireless power reception apparatus and a wireless power transmission apparatus including the reception coil antenna structure shown in FIG. 2;

FIG. 5 is a diagram for explanation of an embodiment of a reception coil included in a wireless power reception device according to an embodiment;

FIG. 6 is a diagram for explanation of an embodiment of a reception coil included in a wireless power reception device according to another embodiment;

FIG. 7 is a diagram for explanation of another embodiment of a reception coil included in the wireless power reception device illustrated in FIG. 5; and

FIG. 8 is a diagram for explanation of another embodiment of a reception coil included in a wireless power reception device illustrated in FIG. 6.

### BEST MODE

A wireless power reception apparatus including a metal body according to a first embodiment may include a hole formed in one side of the metal body, a second opening configured to separate an upper or lower portion of the metal body, a first opening configured to be continuously connected to each of the second opening and the hole, and a reception coil configured to receive a magnetic field from a wireless power transmission apparatus for wirelessly transmitting power to the wireless power reception apparatus, wherein an outer diameter of the reception coil is larger than an outer diameter of the hole.

### MODE FOR INVENTION

Reference will now be made in detail to embodiments, examples of which are illustrated in the accompanying drawings. The suffixes “module” and “unit” of elements herein are used for convenience of description and thus may be used interchangeably and do not have any distinguishable meanings or functions.

In description of exemplary embodiments, it will be understood that, when an element is referred to as being “on” or “under” another element, the element can be directly on another element or intervening elements may be present. In addition, when an element is referred to as being “on” or “under” another element, this may include the meaning of an upward direction or a downward direction based on one component.

In the following description of the embodiments, for convenience of description, an apparatus for wirelessly transmitting power in a wireless power transmission system may be used interchangeably with a transmitter, a transmission end, a transmission apparatus, a transmission side, a power transmission apparatus, etc. In addition, an apparatus for wirelessly receiving power may be used interchangeably with a receiver, a terminal, a reception side, a reception apparatus, a power reception apparatus, etc.

A transmitter according to embodiments may be configured in the form of a pad or a cradle and one transmitter may include a plurality of wireless power transmission elements and may wirelessly transmit power to a plurality of receivers.

A receiver according to embodiments may be used in a mobile phone, a smartphone, a laptop computer, a digital broadcasting terminal, a personal digital assistants (PDA), a portable multimedia player (PMP), a navigation system, an MP3 player, other small-size electronic apparatuses, or the like, without being limited thereto and the receiver according to the embodiments may be any apparatus that includes a wireless power reception element according to embodiments to charge a battery.

In the following description of the embodiments, a reception coil that is included in a wireless power reception apparatus and receives an alternating current (AC) signal transmitted from a wireless power transmission apparatus will be interchangeably used with a reception coil antenna or a reception antenna.

In addition, a transmission coil that is included in a wireless power transmission apparatus and transmits an AC signal for wireless charging of a wireless power reception apparatus will be interchangeably used with a transmission coil antenna or a transmission antenna.

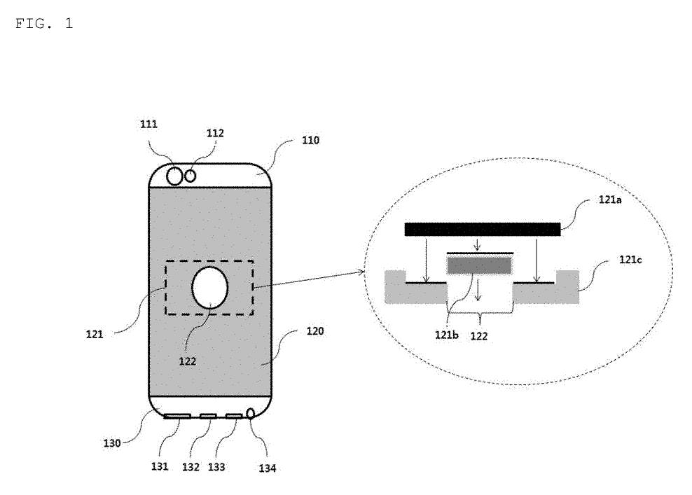

FIG. 1 is a diagram for explanation of a structure of a conventional wireless power reception apparatus.

In detail, FIG. 1 is a diagram for explanation of a structure of a conventional smartphone configured in such a way that a logo of a manufacturer is externally exposed through a logo hole formed in one side of a metal body.

Referring to FIG. 1, a rear surface of a conventional smartphone including a metal body may broadly include an upper body 110, an intermediate body 120, and a lower body 130.

A camera 111 and a flash 112 may be installed at one side of the upper body 110 and an antenna for wireless communication may be installed at one side inside the upper body 110. An entire or partial portion of the upper body 110 may be formed of a plastic material for normal wireless communication instead of a metallic material.

The intermediate body 120 may be formed of a metallic material, and a hole 122 for short-distance wireless communication such as near field communication (NFC) communication or radio frequency identification (RFID) communication may be formed in one side of the intermediate body 120. For example, the hole 122 may be formed in a circular form or a logo form of a corresponding manufacturer but, it may be noted that this is merely an embodiment and the hole 122 is differently formed according to an implemented form and selection of a manufacturer of a smartphone. In addition, the metallic material of the intermediate body 120 may be an aluminum material but, this is merely an embodiment and, various metallic materials such as titanium or tungsten may be applied according to selection of a manufacturer. A logo 121b may be formed of a plastic material that blocks radio waves and does not cause interference of reference numeral 121 and may be installed in the hole 122.

An adhesive sheet 121a for preventing the logo 121b from being separated out of the hole 122 may be installed on one surface of the plastic logo 121b. For example, as indicated by reference numeral 121, a partial region of the adhesive sheet 121a may be attached to one surface of a metal body 121c to fix the plastic logo 121b.

When short-distance communication is not performed through the hole 122, an adhesive sheet according to an embodiment may be an adhesive sheet formed of a metallic material but, this is merely an embodiment and, according to another embodiment, the adhesive sheet may be formed of a plastic material.

The lower body 130 may include a speaker 131, an external power and device connection port 132, a microphone 133, an earphone connection port 134, and so on.

The lower body 130 may be formed of a metallic material or may be entirely or partially formed of a plastic material.

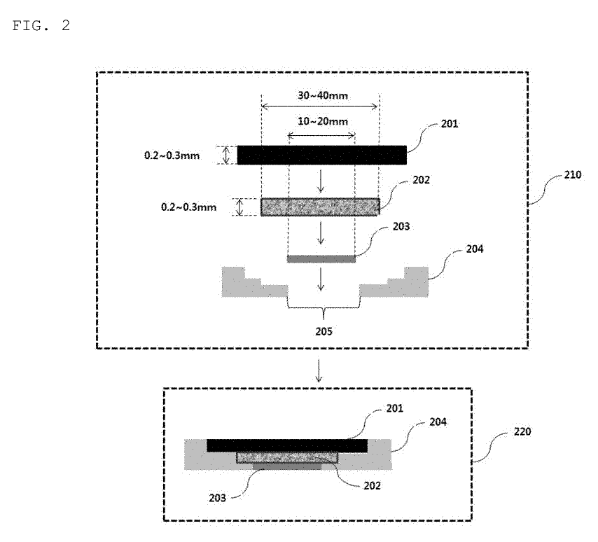

FIG. 2 is a cross-sectional view for explanation of a structure in which a wireless power reception antenna is installed in a wireless power reception device according to an embodiment.

According to an embodiment, as shown by reference numeral 210 in a cross-sectional structure of a smartphone in which a wireless power reception antenna is installed, a plastic logo 203 may be inserted into a hole 205 formed in one side of a metal body 204 or metal housing of a rear surface of a smartphone in such a way that one surface of the plastic logo 203 is externally exposed, a reception coil 202 may be stacked above the plastic logo 203, and a magnetic shield sheet 201 may be stacked above the reception coil 202.

Lastly, the reception coil 202 for wireless power reception may be installed between the plastic logo 203 and the magnetic shield sheet 201 as indicated by reference numeral 220. For example, the plastic logo 203 may have a diameter of 10 to 20 mm and the reception coil 202 may have a diameter of 30 to 40 mm and a thickness of 0.2 to 0.3 mm without being limited thereto, and it is noted that the diameter of the hole 205 may be differently determined depending on the use and structure of a wireless power reception device with a reception coil installed therein, and a diameter and thickness of a transmission coil installed in a wireless power transmitter, and the diameter and thickness of the reception coil 202 are differently determined depending on the diameter of the hole 205. The magnetic shield sheet 201 may have a thickness of 0.2 to 0.3 mm and may have a larger area than the reception coil 202 to sufficiently shield a magnetic field generated by the reception coil 202.

The reception coil 202 may be wound along an outer form of the hole 205 into the plastic logo 203 is inserted, but the scope of the present disclosure is not limited thereto.

A double-sided adhesive sheet may be attached to an upper/lower surface of the reception coil 202 according to an embodiment. In this case, the plastic logo 203 and the magnetic shield sheet 201 may be attached to opposite surfaces of the reception coil 202, respectively and, therethrough, the plastic logo 203 may be fixed to and installed in the hole 205.

According to an embodiment, the reception coil 202 may be disposed inside a metal housing, as shown in FIG. 2. That is, the reception coil 202 may be disposed as adjacent as possible to the metal housing while being insulated from the metal housing (which is for preventing a short phenomenon) rather than being spaced apart from a lower surface of the metal housing by a significant distance and, thus, heat generated from the reception coil 202 may be effectively discharged. Accordingly, an arrangement structure of a reception coil unit may be optimized and an issue in terms of heat dissipation may be overcome. Here, when the reception coil 202 is a coil that is coated to be insulated, the reception coil 202 and the metal housing may be insulated from each other via insulating coating and, when the reception coil 202 is a coil that is not coated to be insulated, the reception coil 202 and the metal housing may be insulated from each other by a separate insulating film.

It may be possible to install the reception coil 202 as adjacent as possible to the metal housing and, thus, a distance for transmission and reception may be reduced to increase mutual inductance, thereby also increasing power transmission efficiency.

The plastic logo 203 according to an embodiment may be configured in the form of a plastic film and the reception coil 202 may be formed of a lead frame pattern coil, without being limited thereto and, the reception coil 202 according to another embodiment may use a litz wire coil, a metal line coil, a copper plate etching coil, a printed circuit board (PCB) pattern coil, a flexible printed circuit board (FPCB), or the like.

For example, a wireless power reception device may be configured by stacking a plastic film for indicating a logo that is externally exposed through a hole formed in one side of a rear surface of a main body of the corresponding device, a lead frame pattern coil installed on one surface of the plastic film, and a magnetic sheet installed on one surface of the lead frame pattern coil.

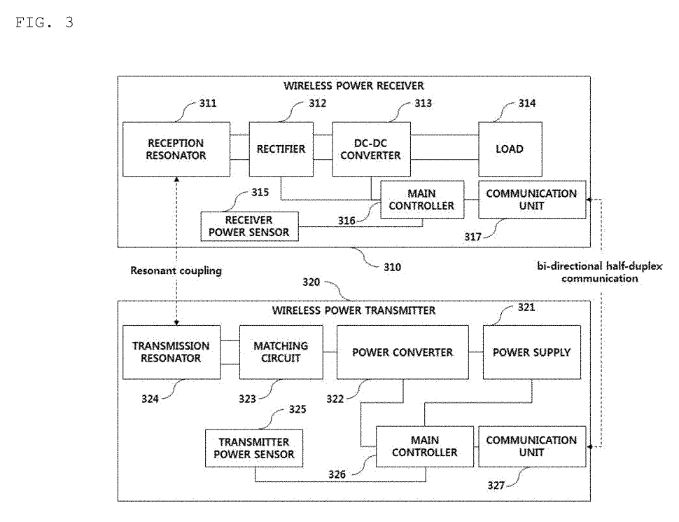

FIG. 3 is a diagram showing a structure of a system for explanation of a wireless power transmission method in a magnetic resonance method according to an embodiment.

Referring to FIG. 3, the wireless power transmission system may include a wireless power transmitter 320 and a wireless power receiver 310.

Although FIG. 3 illustrates the case in which the wireless power transmitter 320 wirelessly transmits power to one wireless power receiver 310, this is merely an embodiment and, thus, according to another embodiment, the wireless power transmitter 320 may wirelessly transmit power to a plurality of wireless power receivers 310. It is noted that, according to another embodiment, the wireless power receiver 310 may wirelessly and simultaneously receive power from a plurality of wireless power transmitters 320.

The wireless power transmitter 320 may generate a magnetic field using a specific power transmission frequency for wireless power transmissions and the wireless power receiver 310 may generate power using a magnetic field received through an included reception coil and may charge an included load with the power.

The wireless power receiver 310 may receive power in synchronization with the same frequency as an operation frequency used by the wireless power transmitter 320.

For example, an operation frequency used for wireless power transmission may be 6.78 MHz, without being limited thereto.

That is, a power signal transmitted by the wireless power transmitter 320 may be transmitted to the wireless power receiver 310 through a resonance phenomenon of each of transmission and reception coils.

A maximum number of wireless power receivers 310 capable of receiving power from one wireless power transmitter 320 may be determined based on a maximum transmission power level of the wireless power transmitter 320, a maximum power reception level of the wireless power receiver 310, physical shapes and structures of the wireless power transmitter 320 and the wireless power receiver 310, and so on.

The wireless power transmitter 320 and the wireless power receiver 310 may perform bi-directional communication with a different frequency band from a frequency band for wireless power transmission—i.e., a resonance frequency band. For example, the bi-directional communication may use a half-duplex Bluetooth low energy (BLE) communication protocol using a band of 2.4 GHz, without being limited thereto and, other short-distance wireless communication such as near field communication (NFC), radio frequency identification (RFID) communication, or ultras wideband (UWB) communication may also be applied to the bi-directional communication.

The wireless power transmitter 320 and the wireless power receiver 310 may exchange each other's characteristics and state information—e.g., which includes power negotiation information for power control—through the bi-directional communication.

For example, the wireless power receiver 310 may transmit predetermined power reception state information for controlling a level of power received from the wireless power transmitter 320 to the wireless power transmitter 320 through bi-directional communication. In this case, the wireless power transmitter 320 may dynamically control a transmitted power level based on the received power reception state information. As such, the wireless power transmitter 320 may optimize power transmission efficiency and may also perform a function of preventing a load from being damaged due to over-voltage, a function of preventing unnecessary power from being wasted due to under-voltage, and so on.

The wireless power transmitter 320 may perform a function of authenticating and identifying the wireless power receiver 310, a function of exchanging configuration and state information of the wireless power receiver 310, a function of detecting a foreign object such as an incompatible apparatus or a non-rechargeable object, a function for identifying a valid load, a function of acquiring charge-completion state information, a function of verifying system error and alarm, a function of distributing power for a plurality of receivers, through bi-directional communication.

Hereinafter, a wireless power transmission procedure of a resonance mode will be described in more detail with reference to FIG. 3.

The wireless power transmitter 320 may include a power supply 321, a power conversion unit 322, a matching circuit 323, a transmission resonator 324, a transmitter power sensor 325, a main controller 326, and a communication unit 327. Here, the communication unit 327 may include a data transmitter for transmission of control information to the wireless power receiver and a data receiver for reception of control information from the wireless power receiver.

The power supply 321 may apply a specific supply voltage to the power conversion unit 322 according to control of the main controller 326. In this case, the supply voltage may be a DC voltage or an AC voltage.

The power conversion unit 322 may convert a voltage received from the power supply 321 into a specific voltage under control of the main controller 326. To this end, the power conversion unit 322 may include at least one of a DC/DC convertor, an AC/DC convertor, or a power amplifier.

The matching circuit 323 may be a circuit for matching impedance between the power conversion unit 322 and the transmission resonator 324 in order to maximize power transmission efficiency.

The transmission resonator 324 may wirelessly transmit power using a specific resonance frequency according to a voltage applied from the matching circuit 323.

The transmitter power sensor 325 may measure the intensity of voltage, current, and power of each end of a transmitter and may provide the measurement result to the main controller 326. For example, the transmitter power sensor 325 may measure the intensity of output voltage/current of the power supply 321, the intensity and phase of output voltage/current of the power conversion unit 322, the intensity and phase of output voltage/current of the matching circuit 323, and so on and may forward the measurement result to the main controller 326.

The wireless power transmitter 320 according to an embodiment may further include a predetermined temperature sensor for measuring internal temperature of the wireless power transmitter 320. In this case, the temperature sensor may provide measured temperature information to the main controller 326, and the main controller 326 may determine whether heat is excessively generated based on the temperature information received from the temperature sensor and may also control power transmission based the determination result.

The wireless power receiver 310 may include a receiving resonator 311, a rectifier 312, a DC-DC converter 313, a load 314, a receiver power sensor 315, a main controller 316, and a communication unit 317. The communication unit may include a data transmitter and a data receiver.

The receiving resonator 311 may receive power transmitted by the transmission resonator 324 through magnetic coupling and resonance.

The rectifier 312 may perform a function of converting an AC voltage applied through the receiving resonator 311 into a DC voltage.

The DC-DC converter 313 may convert the rectified DC voltage into a specific DC voltage required by the load 314.

The receiver power sensor 315 may measure the intensity and phase of voltage and current of each end of the receiver and may provide the measurement result to the main controller 316. For example, the receiver power sensor 315 may measure the intensity and phase of output voltage/current of the receiving resonator 311, the intensity of output voltage/current of the rectifier 312, the intensity of output voltage/current of the DC-DC converter 313, and so on, and may forward the measurement information to the main controller 316.

The wireless power receiver 310 according to an embodiment may further include a predetermined temperature sensor for measuring internal temperature of the wireless power receiver 310. In this case, the temperature sensor may provide the measured temperature information to the main controller 316 and the main controller 316 may determine whether heat is excessively generated based on the temperature information received from the temperature sensor and, as the determination unit, upon detecting that heat is excessively generated, the main controller 316 may transmit a predetermining alarm message indicating that heat is excessively generated to the wireless power transmitter 320 through the communication unit 317.

The main controller 316 may control operations of the rectifier 312 and the DC-DC converter 313 or may generate the characteristics and state information of the wireless power receiver 310 and may transmit the generated characteristics and state information to the wireless power transmitter 320 through the communication unit 317. For example, when the main controller 316 monitors the intensity of the output voltage and current in the rectifier 312 and the DC-DC converter 313 and detects over-voltage/over-current, the main controller 316 may control an over-voltage/over-current block circuit included therein to prevent over-voltage/over-current from being transmitted to the load.

For example, information on the monitored intensity of the output voltage and current of the rectifier may be transmitted to the wireless power transmitter 320 through the communication unit 317.

The main controller 316 may compare the rectified DC voltage with a predetermined reference voltage to determine whether a current state is an over-voltage state or an under-voltage state, and upon detecting a system error state as the determination result, the main controller 316 may transmit the detection result to the wireless power transmitter 320 through the communication unit 317.

Upon detecting a system error state, the main controller 316 may control operations of the rectifier 312 and the DC-DC converter 313 or may control a predetermined over current cutoff circuit including a switch and/or a Zener diode in order to prevent a load from being damaged and, thus, may perform control not to apply a voltage equal to or greater than a predetermined reference value to the load 314.

Although FIG. 3 illustrates the case in which the main controller 316 or 326 and the communication unit 317 or 327 are configured as different modules, this is merely an embodiment and, thus, according to another embodiment, it is noted that the main controller 316 or 326 and the communication unit 317 or 327 may be configured as one module.

when the wireless power transmitter 320 according to an embodiment detects an event of adding a new wireless power receiver to a charging region during charging, an event of releasing connection with a wireless power receiver that is being charged, an event of completing charging of the wireless power receiver, or the like, the wireless power transmitter 320 may also perform a power redistribution procedure on the remaining charging target wireless power receivers. In this case, the power redistribution result may be transmitted to the connected wireless power receiver(s) through out-of-band communication.

Although FIG. 3 illustrates the system for explanation of the wireless power transmission method in the magnetic resonance method according to an embodiment, this is merely an embodiment and, according to another embodiment, it is noted that a wireless charging system is also configured using a wireless power transmission method via electromagnetic induction. The electromagnetic induction method may exchange a control signal through in-band-communication instead of half-duplex out-of-band communication, without being limited thereto.

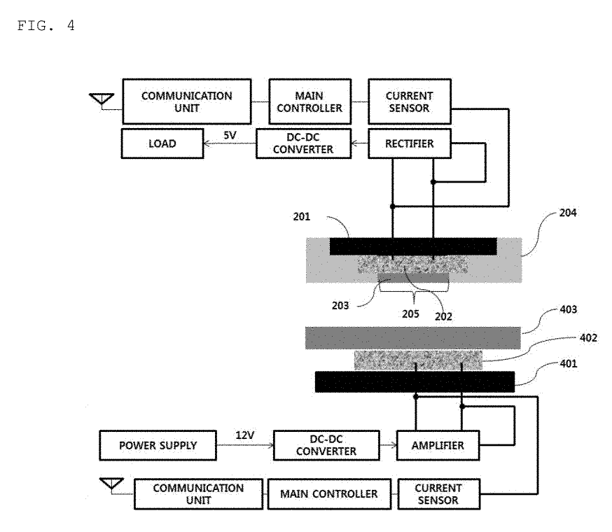

FIG. 4 is a diagram for explanation of operations of a wireless power reception apparatus and a wireless power transmission apparatus including the reception coil antenna structure shown in FIG. 2.

As shown in FIG. 4, the wireless power transmission apparatus may include a DC/DC converter, an amplifier, a main controller (MCU), a current sensor, a communication unit, and so on.

The wireless power reception apparatus may include a rectifier for converting an AC signal received through the reception coil 202 into a DC signal, a DC/DC converter for converting the rectified DC signal into a specific DC voltage, a current sensor for measuring current of a specific port in the wireless power reception apparatus, a main control unit (MCU), a communication unit, and so on. Here, the communication unit may have a Bluetooth low power communication function installed therein, without being limited thereto. When the wireless power reception apparatus supports the electromagnetic induction method, the communication unit may have an in-band communication function installed therein.

The wireless power reception apparatus may further include a reception impedance matching unit. The reception impedance matching unit may be disposed between a reception coil and a rectifier to change impedance of a reception apparatus and, therethrough, may be capable of transmitting maximum power depending on change in a state of a battery.

Referring to FIG. 4, a transmission coil antenna of a wireless power transmitter may include a magnetic shield member 401 for preventing magnetic force being transmitted to a transmitter circuit, and a transmission coil 402 positioned between the magnetic shield member 401 and a charging bed 403.

AC power—i.e., magnetic field—transmitted through the transmission coil 402 may be transmitted to the reception coil 202 through the plastic logo 203 installed at one side of the metal body 204 of the wireless power reception apparatus.

When the size of the transmission coil 402 is smaller than the size of the metal body 204 or the center of the hole 205 of the metal body 204 corresponds to the center of the transmission coil 402, the size of the transmission coil 402 may be determined in such a way that the outermost wire of the transmission coil 402 does not overlap an edge of the metal body 204. However, when the metal body is 150% or more of the size of an opening, the size of the transmission coil may be larger than the metal body.

The size of the hole 205 may be appropriately determined to transfer 10 to 50% of an entire magnetic field generated by the transmission coil 402 directly to the reception coil 202. The size of the metal body 204 may be appropriately determined to apply 75% or more of an entire magnetic field generated by the transmission coil 402.

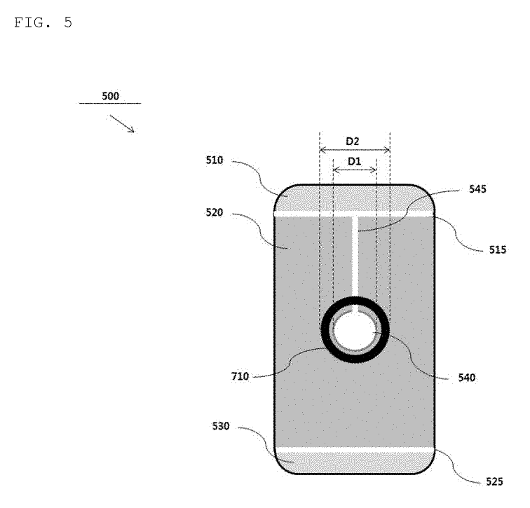

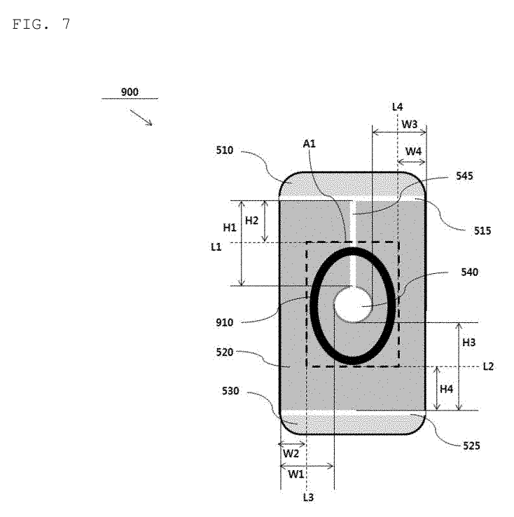

FIG. 5 is a diagram for explanation of an embodiment of a reception coil included in a wireless power reception device according to an embodiment. The wireless power reception device according to the present embodiment may be a smartphone having a metal body, without being limited thereto. Referring to FIG. 5, a wireless power reception device 500 shown in FIG. 7 corresponds to an embodiment of a rear surface (a surface viewed from the inside of an apparatus) of a wireless power reception device.

The wireless power reception device 500 may broadly include at least one of an upper body 510, an intermediate body 520, or a lower body 530. Here, at least one of the upper body 510, the intermediate body 520, or the lower body 530 may be formed of a metal body.

Slits 515 and 525 for design of a mobile communication antenna, a camera module, a speaker, or the like may be configured and separated from each other between the intermediate body 520 and the upper body 510 or the lower body 530. Hereinafter, for convenience of description, the slits formed between the intermediate body 520 and the upper body 510, and between the intermediate body 520 and the lower body 530 may be collectively referred to as second openings 515 and 525. However, when the slit formed between the intermediate body 520 and the upper body 510 and the slit formed between the intermediate body 520 and the lower body 530 need to be separated for description, the slit formed between the intermediate body 520 and the upper body 510 will be referred to as the upper second opening 515, and the slit formed between the intermediate body 520 and the lower body 530 will be referred to as the lower second opening 525.

A hole 540 may be formed in one side of the intermediate body 520 and, a reception coil may be disposed around the hole 540. Needless to say, a plastic film with a specific log printed thereon may be attached into the hole 540 or a component formed of a non-conductive material may be manufactured in the form of the hole 540 and may be installed in the hole 540. The hole 540 may be assumed to be positioned at the center of the intermediate body 520. When the hole 540 is positioned in the center of the intermediate body 520, it may be easy to position the hole 540 in a chargeable region by a transmission coil. Accordingly, when the hole 540 that directly receives a magnetic field by the transmission coil is positioned in the center of the intermediate body 520, charging efficiency may be increased and temperature increase may be prevented. Temperature increase may cause interference in the wireless power transmission apparatus as well as the wireless power reception device to cause failure or to also abnormally terminate wireless charging.

The wireless power reception device 500 may further include a first opening 545.

The first opening 545 may be continuously connected to the upper second opening 515 and may be continuously connected to an outer diameter of the hole 540. In other some embodiments, the first opening 545 may be continuously connected to the lower second opening 525, a left edge of the intermediate body 520, or a right edge of the intermediate body 520 and may be continuously connected to an outer diameter of the hole 540.

The first opening 545 may be formed of a non-conductive material. For example, the non-conductive material may include a plastic material without being limited thereto.

As shown in FIG. 5, the width of the first opening 545 may be smaller than the diameter of the hole 540. For example, when the hole 540 has a diameter of 13 mm, the first opening 545 may be formed with a width less than 5 mm, without being limited thereto.

A reception coil 710 may be wound in a circular form along the outer diameter of the hole 540. Accordingly, the inner diameter of the reception coil 710 may be a diameter of the innermost coil, and the outer diameter of the reception coil 710 may be a diameter of the outermost coil.

An outer diameter D2 of the reception coil 710 may be larger than an outer diameter D1 of the hole 540, and an inner diameter of the reception coil 710 may also be larger than the outer diameter D1 of the hole 540. Accordingly, maximum efficiency may be achieved at a reception coil configured with a plurality of turns.

In other some embodiments, the outer diameter D2 of the reception coil 710 may be larger than the outer diameter D1 of the hole 540, and an inner diameter of the reception coil 710 may be less than the outer diameter D1 of the hole 540.

As shown in FIG. 7, when the reception coil 710 is wound along the hole 540, relatively high wireless power reception efficiency may be achieved. That is, as the reception coil 710 is wound along the hole 540, a magnetic field transmitted to the reception coil 710 may be maximized to achieve high wireless power reception efficiency due to a positional relationship between the hole 540 and the reception coil 710.

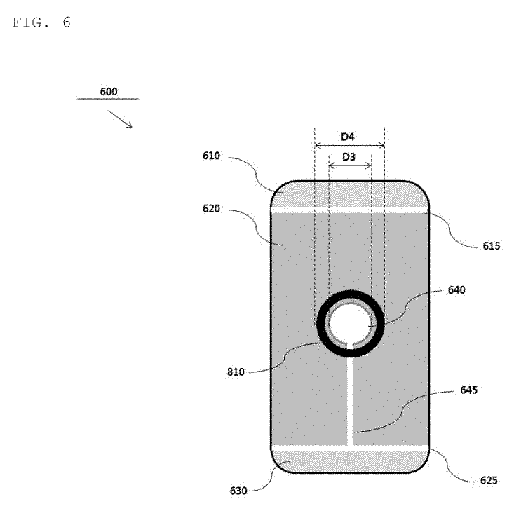

FIG. 6 is a diagram for explanation of an embodiment of a reception coil included in a wireless power reception device according to another embodiment.

Referring to FIG. 6, a structure of a wireless power reception device 600 is not different from the structure of the wireless power reception device 500 of FIG. 5 unless the context clearly indicates otherwise and, thus, a repeated description will be omitted.

A first opening 645 may be continuously connected to a lower second opening 625 and may be continuously connected to an outer diameter of a hole 640. In other some embodiments, the first opening 645 may be continuously connected to an upper opening 615, a left edge of the intermediate body 620, or a right edge of the intermediate body 620 and may be continuously connected to an outer diameter of the hole 640.

The wireless power reception device 600 shown in FIG. 6 may correspond to another embodiment of a rear surface (a surface viewed from the inside of an apparatus) of the wireless power reception device.

A reception coil 810 may be wound in a circular shape along the outer diameter of the hole 640. Accordingly, an inner diameter of the reception coil 810 may be a diameter of the innermost coil, and the outer diameter of the reception coil 810 may be a diameter of the outermost coil.

An outer diameter D4 of the reception coil 810 may be larger than the outer diameter D1 of the hole 640, and an inner diameter of the reception coil 810 may also be larger than the outer diameter D1 of the hole 640.

In other some embodiments, the outer diameter D2 of the reception coil 810 may be larger than the outer diameter D1 of the hole 640, and an inner diameter of the reception coil 810 may be less than the outer diameter D1 of the hole 640.

As shown in FIG. 6, when the reception coil 810 is wound along the hole 640, relatively high wireless power reception efficiency may be achieved. That is, as the reception coil 810 is wound along the hole 640, a magnetic field transmitted to the reception coil 810 may be maximized to achieve high wireless power reception efficiency due to a positional relationship between the hole 640 and the reception coil 810.

FIG. 7 is a diagram for explanation of another embodiment of a reception coil included in the wireless power reception device illustrated in FIG. 5.

Referring to FIG. 7, a wireless power reception device 900 shown in FIG. 7 may correspond to another embodiment of a rear surface (a surface viewed from the inside of an apparatus) of the wireless power reception device 500 of FIG. 5.

A reception coil 910 may be wound along the outermost diameter of the hole 540 like the reception coil 710 illustrated in FIG. 5. However, the form of the reception coil 910 may be modified and manufactured for various reasons (e.g., a lower design structure of a metal body).

For example, the reception coil 910 may have a larger outer diameter and inner diameter than the reception coil 710 of FIG. 5 and may have an oval shape instead of a circular shape.

For high wireless power reception efficiency, a predetermined design condition for the reception coil 910 may be required.

Referring to FIG. 7, when a distance between the upper second opening 515 and the uppermost end of the hole 540 is a first height H1 and ½ of the first height H1 is a second height H2, a line that is spaced apart from the upper second opening 515 by the second height H2 may be a first line L1.

Similarly, when a distance between the lower second opening 525 and the lowermost end of the hole 540 is a third height H3 and ½ of the third height H3 is a fourth height H4, a line that is spaced apart from the lower second opening 525 by the fourth height H4 may be a second line L2.

When an upper outer diameter (the uppermost end of the coil) of the reception coil 910 is close to the upper second opening 515 over the first line L1 or a lower outer diameter (the lowermost end of the coil) of the reception coil 910 is close to the lower second opening 525 over the second line L2, wireless power reception efficiency may be remarkably degraded.

Accordingly, the reception coil 910 may be disposed between the first line L1 and the second line L2.

When a distance between a left edge of the intermediate body 520 and a left end of the hole 540 is a first width W1 and ½ of the first width W1 is a second width W2, a line that is spaced apart from the left edge of the intermediate body 520 by the second width W2 may be a third line L3.

Similarly, when a distance between a right edge of the intermediate body 520 and a right edge of the hole 540 is a third width W3 and ½ of the third width W3 is a fourth width W4, a line that is spaced apart from the right edge of the intermediate body 520 by the fourth width W4 may be a fourth line L4.

When a left outer diameter (the leftmost end of the coil) of the reception coil 910 is closed to a left edge of the intermediate body 520 over the third line L3 or a right outer diameter (the rightmost end of the coil) of the reception coil 910 is close to a right edge of the intermediate body 520 over the fourth line L4, wireless power reception efficiency may be remarkably degraded.

Accordingly, the reception coil 910 may be disposed between the third line L3 and the fourth line L4.

A region defined between the first line L1 and the second line L2 and between the third line L3 and the fourth line L4 may be defined as a first region A1. That is, the reception coil 910 may be disposed inside the first region A1 to enhance wireless power reception efficiency.

In the example of FIG. 7, a reference for determining the first region A1 is described as a specific ratio (e.g., the first line L1 is determined to be the second height H2 that is 50% of the first height H1) but, the scope of the present disclosure is not limited thereto. For example, the specific ratio may be differently determined depending on the structure of the wireless power reception device 900, the size of the hole 540, inductance of the reception coil 910, and so on. A ratio for determination of each of the first line L1 to the fourth line L4 may be differently set.

The wireless power reception device according to embodiments may minimize reduction in wireless power transmission efficiency due to influence of a metal body and may minimize heat generated from the metal body.

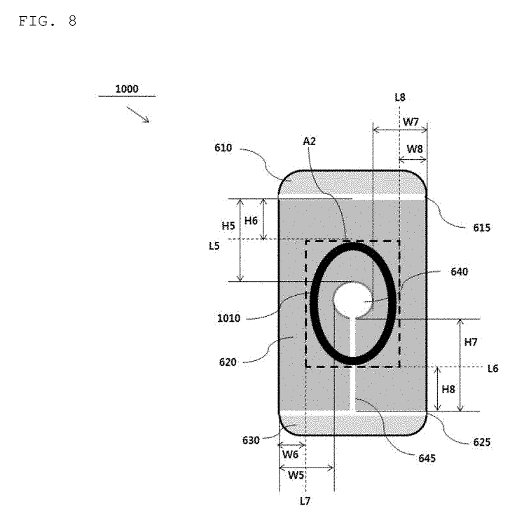

FIG. 8 is a diagram for explanation of another embodiment of a reception coil included in a wireless power reception device illustrated in FIG. 6.

Referring to FIG. 8, a wireless power reception device 1000 shown in FIG. 8 may correspond to another embodiment of a rear surface (a surface viewed from the inside of an apparatus) of the wireless power reception device 600 of FIG. 6.

A reception coil 1010 may be wound along the outer diameter of the hole 640 like the reception coil 810 shown in FIG. 6. However, the form of the reception coil 1010 may be modified and manufactured for various reasons (e.g., a lower design structure of a metal body).

For example, the reception coil 1010 may have a larger outer diameter and inner diameter than the reception coil 810 of FIG. 6 and may have an oval shape instead of a circular shape.

For high wireless power reception efficiency, a predetermined design condition for the reception coil 1010 may be required.

Referring to FIG. 8, when a distance between the upper opening 615 and the uppermost end of the hole 640 is a fifth height H5 and ½ of the fifth height H5 is a sixth height H6, a line that is spaced apart from the upper opening 615 by the sixth height H6 may be a fifth line L5.

Similarly, when a distance between the lower second opening 625 and the lowermost end of the hole 640 is a seventh height H7 and ½ of the seventh height H7 is an eighth height H8, a line that is spaced apart from the lower second opening 625 by the eighth height H8 may be a sixth line L6.

When an upper outer diameter (the uppermost end of the coil) of the reception coil 1010 is close to the upper opening 615 over the fifth line L5 or a lower outer diameter (the lowermost end of the coil) of the reception coil 1010 is close to the lower second opening 625 over the sixth line L6, wireless power reception efficiency may be remarkably degraded.

Accordingly, the reception coil 1010 may be disposed between the fifth line L5 and the sixth line L6.

When a distance between a left edge of the intermediate body 620 and a left end of the hole 640 is a fifth width W5 and ½ of the fifth width W5 is a sixth width W6, a line that is spaced apart from the left edge of the intermediate body 620 by the sixth width W6 may be a seventh line L7.

Similarly, when a distance between a right edge of the intermediate body 620 and a right edge of the hole 640 is a seventh width W7 and ½ of the seventh width W7 is an eighth width W8, a line that is spaced apart from the right edge of the intermediate body 620 by the eighth width W8 may be an eighth line L8.

When a left outer diameter (a left end of the coil) of the reception coil 1010 is close to the left edge of the intermediate body 620 over the seventh line L7 or a right outer diameter (a right end of the coil) of the reception coil 1010 is close to a right edge of the intermediate body 620 over the eighth line L8, wireless power reception efficiency may be remarkably degraded.

Accordingly, the reception coil 1010 may be disposed between the seventh line L7 and the eighth line L8.

A region defined between the fifth line L5 and the sixth line L6 and between the seventh line L7 and the eighth line L8 may be defined as a second region A2. That is, the reception coil 1010 may be disposed inside the second region A2 to enhance wireless power reception efficiency.

In the example of FIG. 8, a reference for determining the second region A2 is described as a specific ratio (e.g., the fifth line L5 is determined to be the sixth height H6 that is 50% of the first height H1) but, the scope of the present disclosure the fifth height H5) but, the scope of the present disclosure is not limited thereto. For example, the specific ratio may be differently determined depending on the structure of the wireless power reception device 1000, the size of the hole 640, inductance of the reception coil 1010, and so on. A ratio for determination of each of the fifth line L5 to the eighth line L8 may be differently set.

The wireless power reception device according to embodiments may minimize reduction in wireless power transmission efficiency due to influence of a metal body and may minimize heat generated from the metal body.

That is, when the size of the reception coil is smaller than the transmission coil, higher transmission efficiency may he achieved using a metal body using an opening than in the case in which only a transmission and reception coil is used without a metal body.

The reception coil may be installed in the metal body to maximum heat conduction and to minimize an installation volume of a reception coil unit, thereby also enhancing transmission efficiency.

Those skilled in the art will appreciate that the disclosure may be carried out in other specific ways than those set forth herein without departing from the spirit and essential characteristics of the disclosure.

It will be apparent to those skilled in the art that various modifications and variations can be made in the disclosure without departing from the spirit or scope of the disclosure. Thus, it is intended that the disclosure cover the modifications and variations of the embodiment provided they come within the scope of the appended claims and their equivalents.

### INDUSTRIAL APPLICABILITY

The present disclosure may be related to wireless charging technology and may be applicable to a wireless power reception apparatus for wirelessly receiving power.

1.-14. (canceled)

15. A wireless power reception apparatus comprising:
a metal body;
a hole formed in one side of the metal body;
a second opening configured to separate upper and lower portions of the metal body;
a first opening configured to be continuously connected to each of the second opening and the hole; and
a reception coil configured to wirelessly receive power,
wherein an outer diameter of the reception coil is larger than an outer diameter of the hole.

16. The wireless power reception apparatus of claim 15, wherein the reception coil is disposed as adjacent as possible to one surface of the metal body while being insulated therefrom.

17. The wireless power reception apparatus of claim 15, wherein one surface of the metal body includes a first concave portion formed around the hole, and
wherein the reception coil is disposed at the first concave portion.

18. The wireless power reception apparatus of claim 17, wherein the metal body further includes a second concave portion formed outside the first concave portion, and further includes a shield sheet that contacts the reception coil and is disposed at the second concave portion.

19. The wireless power reception apparatus of claim 15, wherein the reception coil is wound in a circular form along the outer diameter of the hole.

20. The wireless power reception apparatus of claim 15, wherein the reception coil is wound in a circular form to form a diameter of a long axis in a direction toward the first opening along the outer diameter of the hole.

21. The wireless power reception apparatus of claim 15, wherein an inner diameter of the reception coil is smaller than the outer diameter of the hole.

22. The wireless power reception apparatus of claim 15, wherein an inner diameter of the reception coil is larger than the outer diameter of the hole.

23. The wireless power reception apparatus of claim 15, wherein an inner diameter of the reception coil corresponds to the outer diameter of the hole.

24. The wireless power reception apparatus of claim 15, wherein the second opening includes:
an upper second opening configured to separate an upper portion of the metal body and a first region in which the reception coil is disposed; and
a lower second opening configured to separate a lower portion of the metal body and the first region.

25. The wireless power reception apparatus of claim 24, wherein the first opening is continuously connected between the hole and any one of the upper second opening and the lower second opening.

26. The wireless power reception apparatus of claim 25, wherein the first region is defined by a first line and a second line that are spaced apart from the upper second opening and the lower second opening by a predetermined height, respectively, and a third line and a fourth line that are spaced apart from a left edge of the metal body and a right edge of the metal body by a predetermined width, respectively.

27. The wireless power reception apparatus of claim 26, wherein the predetermined height is a height obtained by reducing a distance between the upper second opening and an upper outer diameter of the hole or a distance between the lower second opening and a lower outer diameter of the hole by a first ratio, and
wherein the predetermined width is a width obtained by reducing a distance between a left edge of the metal body and a left outer diameter of the hole or a distance between a right edge of the metal body and a right outer diameter of the hole by a second ratio.

28. The wireless power reception apparatus of claim 27, wherein the first ratio and the second ratio are each 50%.

29. The wireless power reception apparatus of claim 15, wherein the first opening and the second opening are formed of a non-conductive material.

30. The wireless power reception apparatus of claim 15, further comprising a plastic film attached to one surface of the reception coil through an adhesive sheet and having one surface that is externally exposed through the hole.

31. The wireless power reception apparatus of claim 15, wherein a diameter and a coil thickness of the reception coil are determined depending on a diameter of the hole formed in the metal body.

32. The wireless power reception apparatus of claim 15, wherein a diameter of the hole formed in the metal body is determined depending on a diameter of a transmission coil installed in the wireless power transmission apparatus.
